(19) United States
(12) Patent Application Publication
(10) Pub. No.: US 2002/0056039 A1
(43) Pub. Date: May 9, 2002

(54) System for providing certification confirming agency service using double electronic signature

(75) Inventors: Young Sook Lim, Sungnam city (KR); Seung-Jae Lee, Sungnam city (KR); Kyung Hee Kang, Seoul (KR)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: Korea Telecom

(21) Appl. No.: 09/750,493

(22) Filed: Dec. 28, 2000

(30) Foreign Application Priority Data
Nov. 4, 2000 (KR) 2000-65370

(51) Int. Cl. H04L 9/00

(52) U.S. Cl. 713/156

(57) ABSTRACT

Disclosed is a system for providing a sender certification service based on an end-to-end (EtoE) message security and public key infrastructure (PKI) between mobile terminals. The system performs by proxy a verification work of the user's certificate that is difficult to be performed by the mobile terminal having a limited capacity. The system performs by proxy a certification removal list (CRL) check and a certificate validity check with respect to the certificate sent by a sender, and thus the mobile terminal having the limited capacity can directly use the certificate without any CRC check or validity check of the sender's certificate, and effectively perform the PKI based electronic certification service. The system can be usefully applied to all fields that require a PKI based certification security service in the radio network environment in that messages are transmitted/received between the mobile terminals.

### BACKGROUND OF THE INVENTION

1. Field of the Invention

The present invention relates to a system for providing a certification security service based on a message security and public key infrastructure (PKI) between mobile terminals, and more particularly to a system for providing a PKI based electronic certification service in a mobile terminal having a limited capacity which enables the mobile terminal to directly use a certificate without any validity confirming work of the certificate by performing by proxy a verification work of the user's certificate such as confirmation of a certification removal list (CRL) and validity check of the certificate that is difficult to be performed in the mobile terminal having the limited capacity.

2. Description of the Related Art

One of general security services applied to a radio network is a WTLS security service for providing a communication security service between a terminal and a wire/radio gateway system.

However, such a WTLS security service does not provide certification to a terminal user, and has a security problem that a message is exposed through the gateway system.

Also, according to another radio security service, the mobile terminal trusts an application server through a user certification performed between the mobile terminal and the application server, and only the application server performs a sender certification confirmation with respect to a message transmitted from the mobile terminal.

This radio security service is suitable for transferring a message, which is required to be kept in security, upwardly from a radio network to a wire network. However, the radio security service has the drawback in that an end-to-end user certification cannot be provided in the environment that a mobile terminal-to-mobile terminal communication is effected through a path of radio network-wire network-radio network.

### SUMMARY OF THE INVENTION

Therefore, an object of the invention is to solve the problems involved in the related art, and to provide a system for providing a sender certification service for message encoding and denial prevention between the mobile terminals based on the PKI in the radio network environment.

It is another object of the invention to provide a system for providing a certification confirming agency service using a double electronic signature which can effectively perform a PKI based electronic certification service in a mobile terminal having a limited capacity, and thus enables the receiving mobile terminal to directly use a certificate without any validity confirming process of the certificate.

According to the present invention, the mobile terminal performs the certification confirming work to be performed by the mobile terminal, but the certification confirming agency system searches a certification removal list with respect to the certification sent by the sender, and performs by proxy a validity check of the user's certificate such as a validity time check of the certificate, a certificate validity check of a certificate issuing system, etc., that is difficult to be performed by the mobile terminal.

In accordance with the present invention, there is provided a system for providing a certification confirming agency service using a double electronic signature, which comprises a transmitting mobile terminal for receiving a message from a user, performing a security function required for message encoding and electronic signature of a sender, and performing a message transmitting function, an application service system for receiving the message transmitted from the transmitting mobile terminal, requesting a validity check of a sender's certificate and a sender's certification check to a certification confirming agency system, and receiving from the certification confirming agency system and transferring to a receiving mobile terminal a message of the certification confirming result, the certification confirming agency system for receiving a request for confirming the validity of the sender's certificate and a sender's signature value from the application service system, extracting the validity of the sender's certificate and the sender's signature value by analyzing a statement transmitted from the transmitting mobile terminal through the application service system, performing the validity check with respect to the sender's certificate and signature value, and transmitting a result of checking with its signature attached thereto back to the application service system, the receiving mobile terminal for restoring the transmitted statement by receiving and decoding the message from the application service system, and outputting a restored statement so that a receiver can view it, a certificate issuing system for issuing electronic certificates to mobile terminal users, and a certificate directory system for noticing the electronic certificates issued by the certificate issuing system so that wire/wireless subscribers can peruse them through a wire network and a radio network.

### BRIEF DESCRIPTION OF THE DRAWINGS

The above objects, and other features and advantages of the present invention will become more apparent after a reading of the following detailed description when taken in conjunction with the drawings, in which:

FIG. 1 is a block diagram illustrating the construction of a system for providing a certification confirming agency service according to the present invention;

FIG. 2 is a view explaining a double electronic signature of a message used for the certification confirming agency service according to the present invention;

FIG. 3 is a view illustrating the construction of PKIbased key pairs composed of public keys and encoding keys according to the present invention;

FIG. 4 is a view illustrating PKI certificates for signature and certificates for encoding according to the present invention;

FIG. 5 is a view illustrating the message encoding work for transmission of the message from the transmitting mobile terminal to the receiving mobile terminal according to the present invention;

FIG. 6 is a view illustrating the process of creating a first electronic signature for the sender according to the present invention;

FIG. 7 is a view illustrating the construction of a terminal-to-terminal transmission message transmitted from the transmitting mobile terminal to the receiving mobile terminal according to the present invention;

FIG. 8 is a view illustrating the process of creating a second electronic signature for certification of the sender according to the present invention;

FIG. 9 is a view illustrating the construction of a terminal-to-certification confirming agency system transmission message transmitted from the transmitting mobile terminal to the certification confirming agency system according to the present invention;

FIG. 10 is a view illustrating the sender certification confirming process in the certification confirming agency system according to the present invention;

FIG. 11 is a view illustrating the process of verifying the validity of the sender certification performed by the certification confirming agency system according to the present invention;

FIG. 12 is a view illustrating the electronic signature creating process in the certification confirming agency system according to the present invention;

FIG. 13 is a view illustrating the construction of a certification confirming agency system-to-terminal transmission message according to the present invention;

FIG. 14 is a view illustrating the electronic signature confirming process of the certification confirming agency system in the receiving mobile terminal according to the present invention;

FIG. 15 is a view illustrating the terminal-to-terminal message decoding process in the receiving mobile terminal according to the present invention; and

FIG. 16 is a view illustrating the sender's electronic signature confirming process in the receiving mobile terminal according to the present invention.

### DETAILED DESCRIPTION OF THE PREFERRED EMBODIMENT

Hereinafter, a preferred embodiment of the present invention will be described in detail with reference to the annexed drawings.

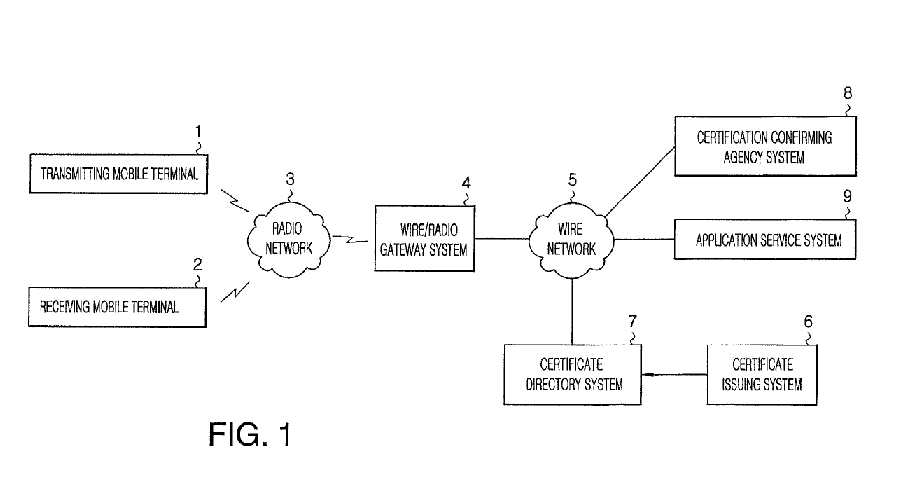

FIG. 1 is a block diagram illustrating the construction of the whole system for providing a certification confirming agency service according to the present invention.

Referring to FIG. 1, the system includes mobile terminals 1 and 2 for transmitting/receiving messages through a radio network 3, a wire/radio gateway system 4 for connecting the radio network 3 and a wire network 5, a certificate issuing system 6 for issuing a certificate to a terminal user, a certificate directory system 7, connected to the wire network 5, for noticing the certificate issued by the certificate issuing system 6 so that a wire/radio network user can peruse the certificate, a certification confirming agency system 8, connected to the wire network 5, for providing a certification confirming agency service, and an application service system 9 for transferring the message transmitted from the transmitting mobile terminal to a receiving mobile terminal.

Here, if the message transferring protocol of the radio network is different from that of the wire network, the wire/radio gateway system 4 converts the protocols between the radio network and the wire network to bidirectionally connect the radio network and the wire network.

The certificate issuing system 6 receives a request for certification issuance from the user of the mobile terminal, investigates the identity of the user, and issues the certificate to the user who meets the certificate issuance standard.

The certificate directory system 7 is a storage device where the certificates of the wire/mobile terminal users are stored for public perusal.

The application service system 9 requests to the certification confirming agency system the validity check of the sender's certificate and the check of the sender's signature with respect to the message transferred from the transmitting mobile terminal.

The operation of the system according to the present invention will now be explained.

The mobile terminal 1 or 2 according to the embodiment of the present invention is a tool for transmitting/receiving messages through a radio network. Hereinafter, the mobile terminal that performs the transmission function is defined as a transmitting mobile terminal 1, and the mobile terminal that performs the receiving function is defined as a receiving mobile terminal 2. At this time, the users of the transmitting and receiving mobile terminals 1 and 2 are different natural persons.

‘Terminal-to-terminal’ means message transmission (i.e., transmission and reception) between the different mobile terminals (In case that the same mobile terminal transmits/receives the message, it does not mean ‘terminal-to-terminal’, but means ‘terminal-to-server’).

According to the present invention, the transmitting mobile terminal 1 encodes the message to be transmitted to the receiving mobile terminal 2, creates the sender's electronic signature, and constructs the end-to-end (EtoE) transmission statement. Then, the transmitting mobile terminal 1 creates again the electronic signature for the whole EtoE transmission statement, and transmits the statement to the application service system 9 that performs the message repeating function.

The application service system 9 certifies the sender by performing the validity check of the sender's certificate and the check of the sender's electronic signature value through the certification confirming agency system 8. If the certificate and the signature value are correct as a result of checking, the application service system 9 attaches the certification validity confirming message for guaranteeing the completion of the certification confirmation and the electronic signature value of the certification confirming agency system 8 to the EtoE transmission statement, and transmits the transmission statement to the receiving mobile terminal 2 through the radio network 3.

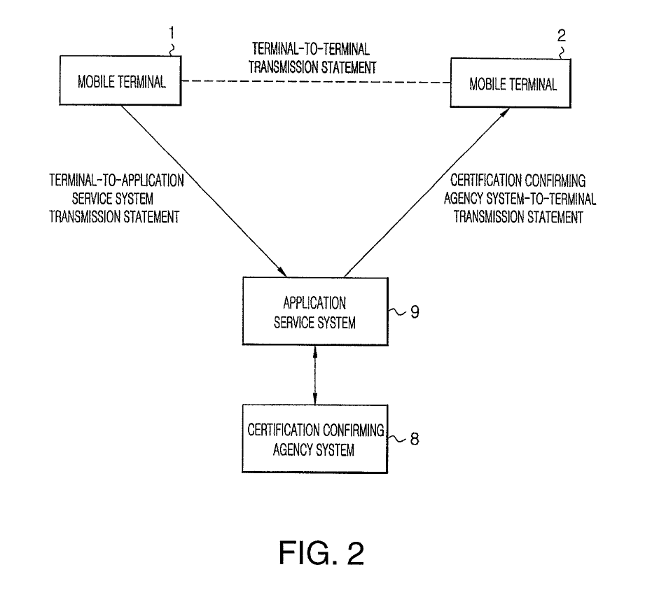

Accordingly, as shown in FIG. 2, since the validity check of the sender's certificate has already been performed by the certification confirming agency system 8, the receiving mobile terminal 2 can perform the message decoding and signature value confirming work directly using the certificate.

At this time, in order to provide the PKI-based message coding and user certification security service, a key pair composed of a private key used for encoding/decoding and a public key is required.

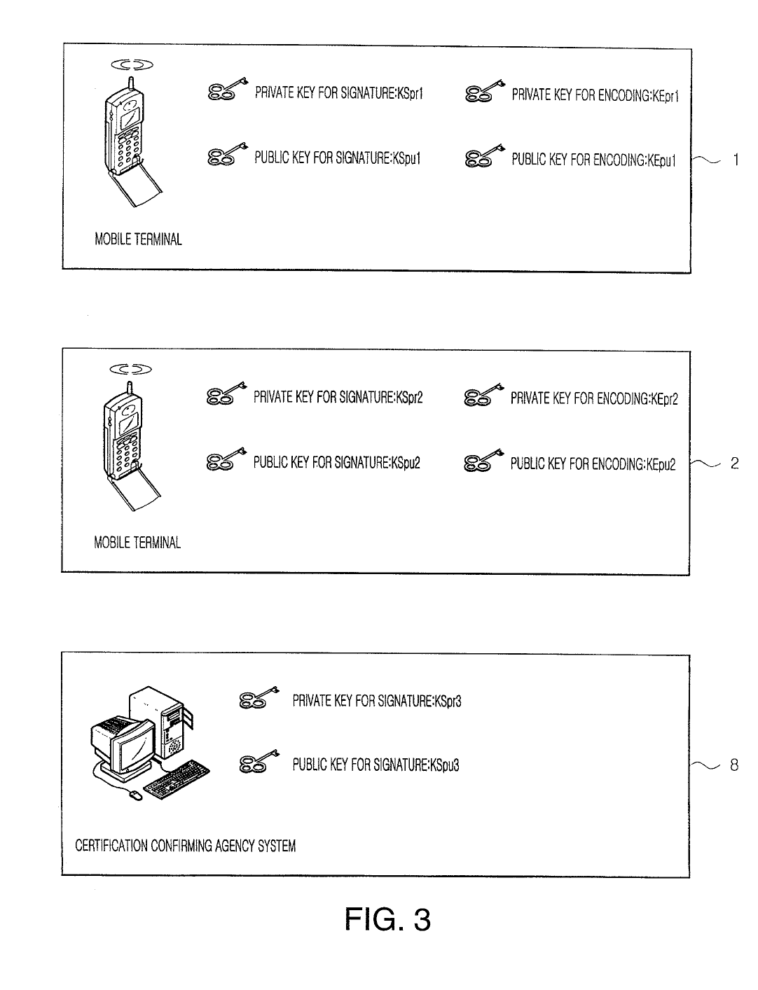

FIG. 3 is a view illustrating the PKI-based key pairs owned by the mobile terminal and the certification confirming agency system 8. The PKI key pairs are named key pairs for signature and key pairs for encoding according to their use. In case of the mobile terminal having a limited capacity, the same key pair may be used for both encoding and signature. The private key is owned only by the key owner, and the public key is included in the certificate and open to the public.

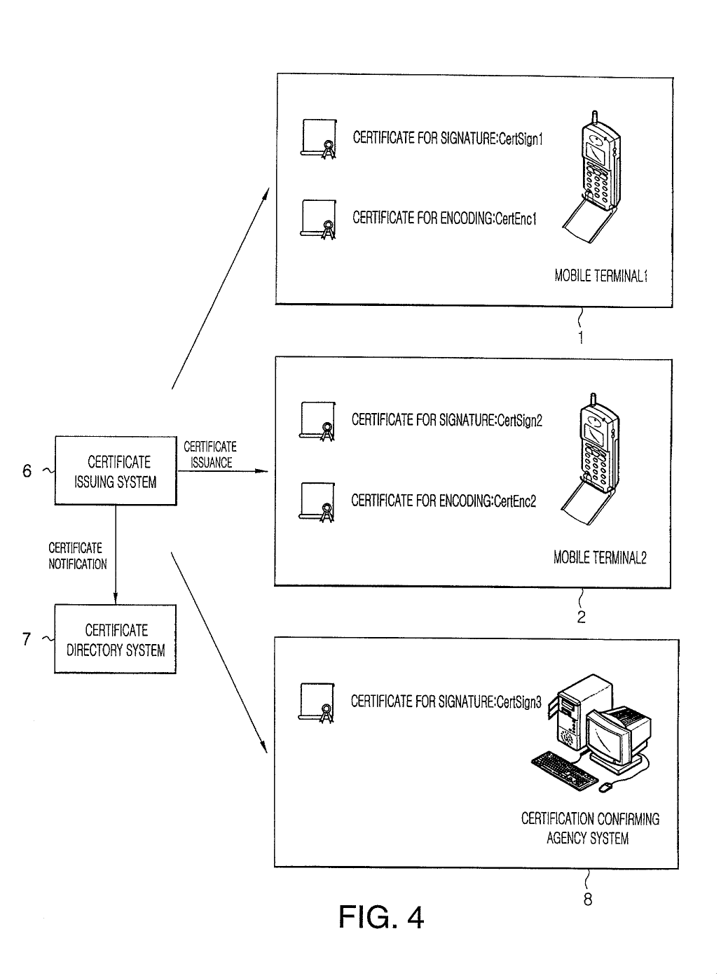

Meanwhile, FIG. 4 is a view explaining the certificate for signature and the certificate for encoding. The certificate issuing system 6 issues the certificate including the public key in accordance with the certificate issuing request, and gives note of the certificate in the certificate directory system 7 that is a public place where anyone can peruse it.

Though the certificate for encoding and the certificate for signature have been described, one certificate may be used for confirmation of the signature value and encoding/decoding of the message in case that the private key/public key is used for the signature and the encoding in the limited environment such as the mobile terminal.

The transmitting mobile terminal 1 is a device for receiving the normal statement message A from the terminal user, and transmitting the message after performing a necessary security work. If the user of the mobile terminal desires the encoding and the sender certification with respect to an important message, the transmitting mobile terminal 1 creates a session key B for one time that is effective only in a communication session where the transmitting mobile terminal 1 is connected to the current receiving mobile terminal 2, and encodes the normal statement message to be transmitted using the session key. At this time, the session key is encoded using the public key for encoding of the receiver so that a just receiver can decode the session key.

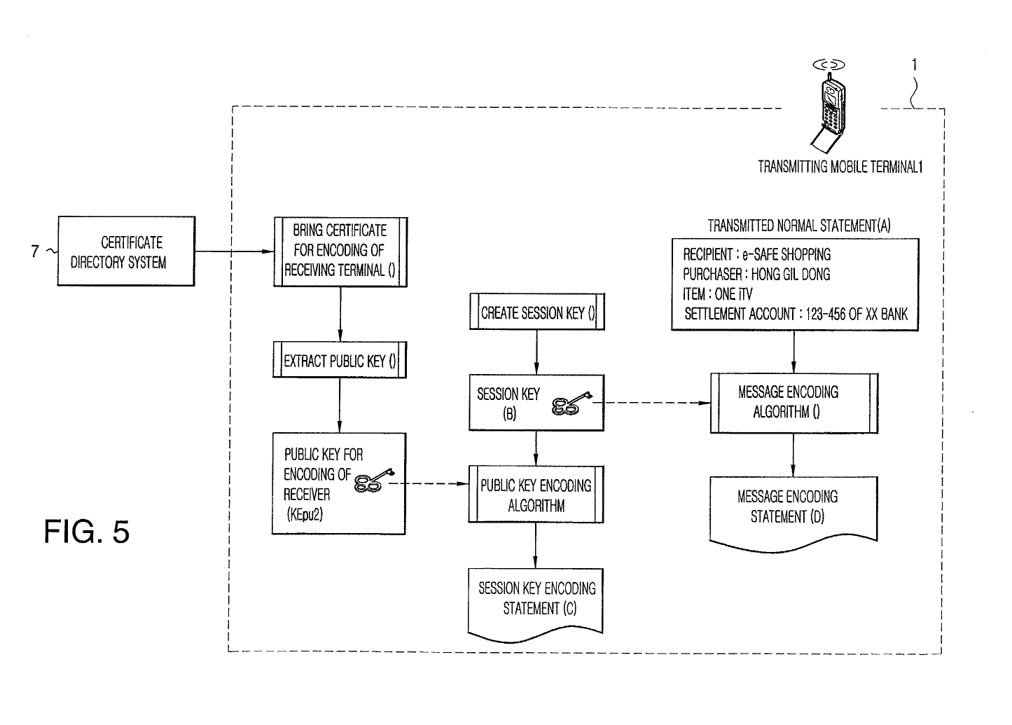

FIG. 5 illustrates the process for encoding the normal statement message and the process for encoding the private key used for the message encoding.

First, the transmitting mobile terminal 1 brings the certificate for encoding of the receiving mobile terminal from the certificate directory system 7 through the certification confirming agency system, and extracts the public key.

At this time, the certification confirming agency system performs the validity check of the certificate for encoding of the receiving mobile terminal, and if the result of the validity check is proper, it transmits the key to the receiving mobile terminal.

The transmitting mobile terminal also creates the session key, and prepares a session key encoding statement C by applying a public key encoding algorithm from the session key and the public key for encoding of the receiver.

Then, the transmitting mobile terminal prepares a message encoding statement D in accordance with a message encoding algorithm based on the session key B in the transmitted normal statement A.

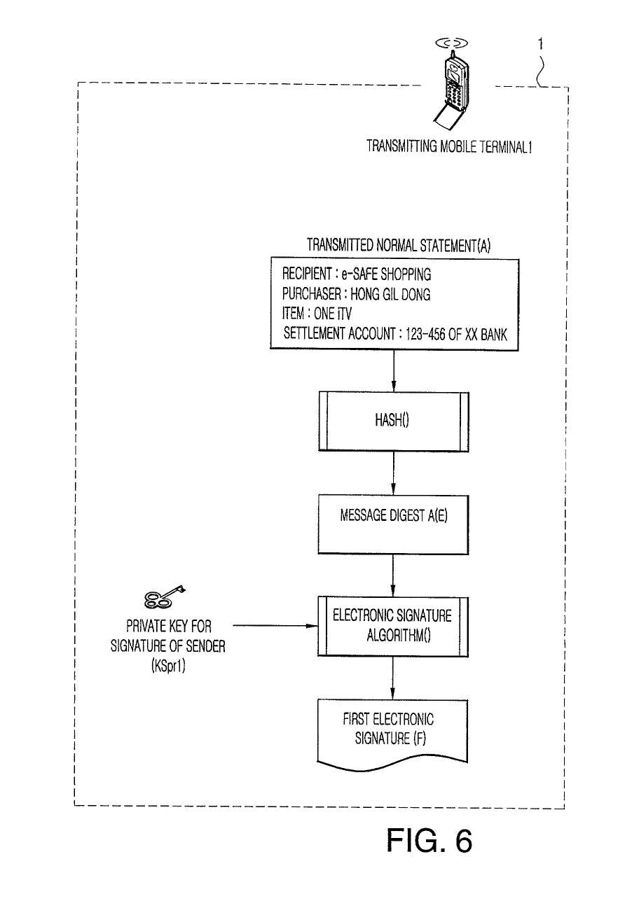

FIG. 6 illustrates the process of creating an electronic signature for the terminal-to-terminal sender certification in the mobile terminal. The transmitting mobile terminal 1 creates a first electronic signature (A) for certifying that the sender has sent the message.

The first electronic signature E is created in a manner that a message digest is created by applying a hash function to the normal statement message inputted by the sender, and the public key algorithm is used with the message digest and the private key for signature used as input data.

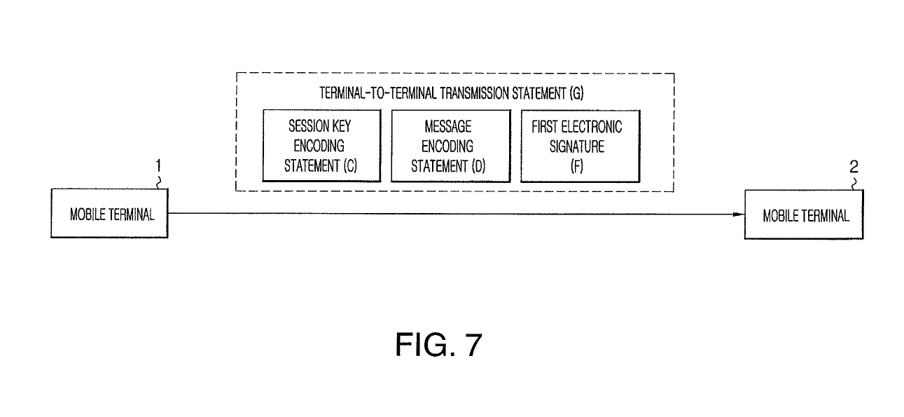

FIG. 7 illustrates a terminal-to-terminal transmission statement G transferred from the transmitting mobile terminal 1 to the receiving mobile terminal 2. This transmission statement includes the session key encoding statement C, message encoding statement D, and first electronic signature F.

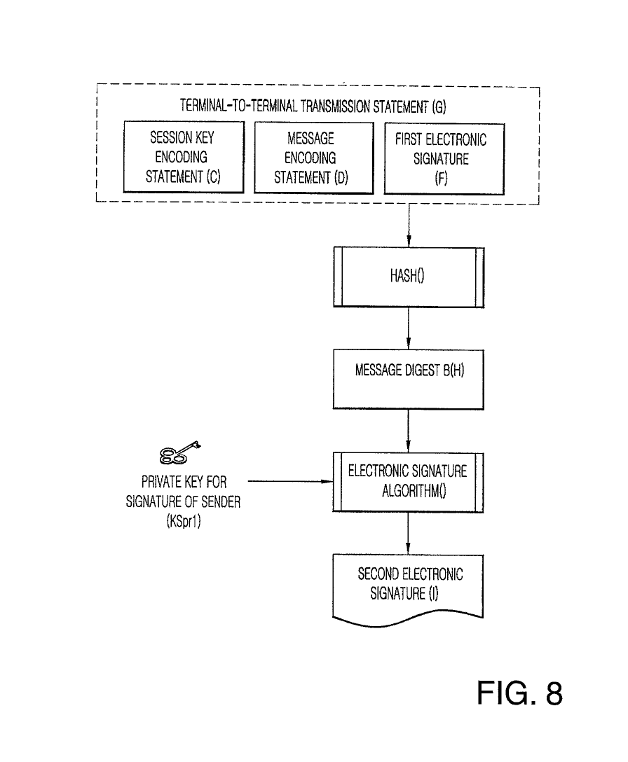

Also, as shown in FIG. 8, the transmitting mobile terminal creates a message digest (B) F by applying the hash function with respect to the whole terminal-to-terminal transmission statement G, creates a second electronic signature by encoding the message digest with the private key for sender signature, and then transmits it to the application service system 9 along with the terminal-to-terminal transmission statement and the sender's certificate.

Accordingly, the application service system 9 request to the certification confirming agency system 8 the validity check of the sender certificate and the check of the sender signature value with respect to the message (i.e., terminal-to-certification confirming agency system transmission statement) transferred from the transmitting mobile terminal.

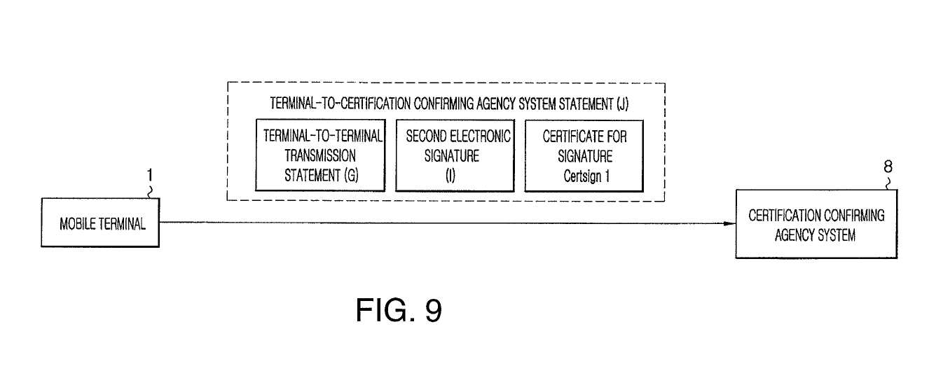

FIG. 9 illustrates the construction of the transmission statement J transferred from the mobile terminal 1 to the certification confirming agency system 8. This transmission statement includes the terminal-to-terminal transmission statement G, second electronic signature I, and certificate for sender's signature, and the terminal-to-terminal transmission statement G, the sender's signature value, and the sender's certificate are extracted by analyzing the terminal-to-certification confirming agency system transmission statement J.

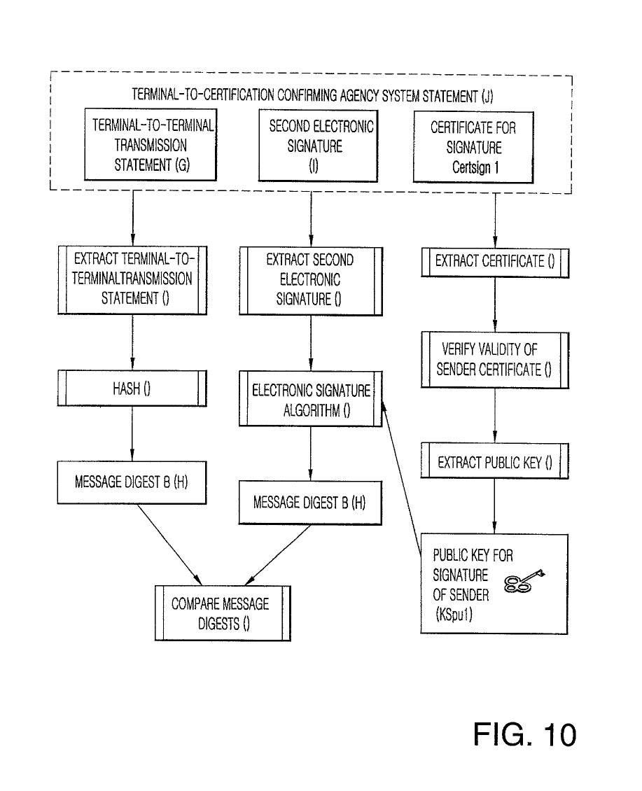

FIG. 10 shows the sender's certification confirming process in the certification confirming agency system 8. If it is identified that the sender's certificate is effective and is not canceled, the public key is extracted from the sender's certificate, and the sender's signature value is checked using the signature algorithm.

Then, the sender's signature value is decoded using the public key for signature of the sender, and if the resultant message (i.e., message digest B) is equal to the message digest value for the terminal-to-terminal transmission statement, it is confirmed that the message is not modulated and is sent by a proper sender.

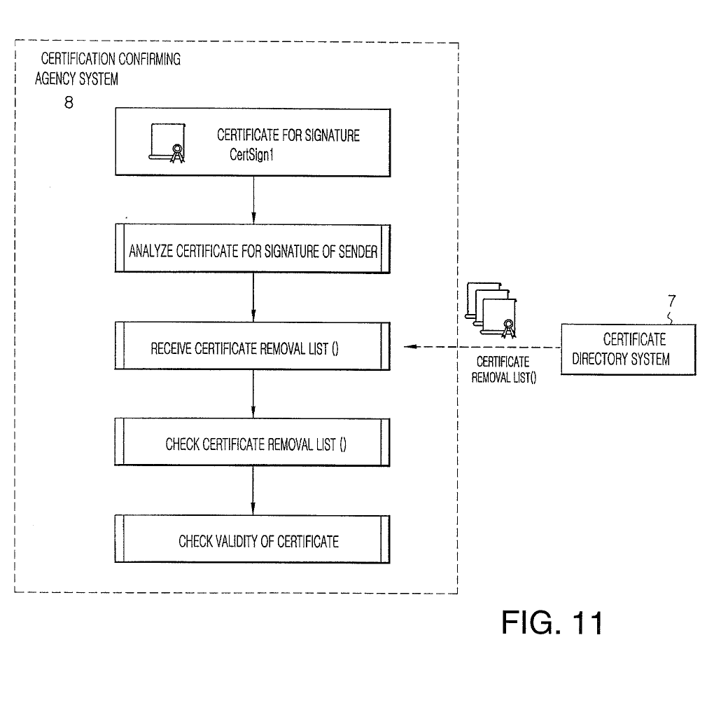

FIG. 11 illustrates the validity certifying process of the sender's certificate. The validity time is checked with respect to the extracted certificate, it is checked whether or not the certificate is canceled by bring the certificate removal list from the certificate directory system 7, and validity of the certificate of the certificate issuer is checked.

After the completion of the validity check of the sender's certificate, the message for verifying the validity of the certificate is created for the certificate.

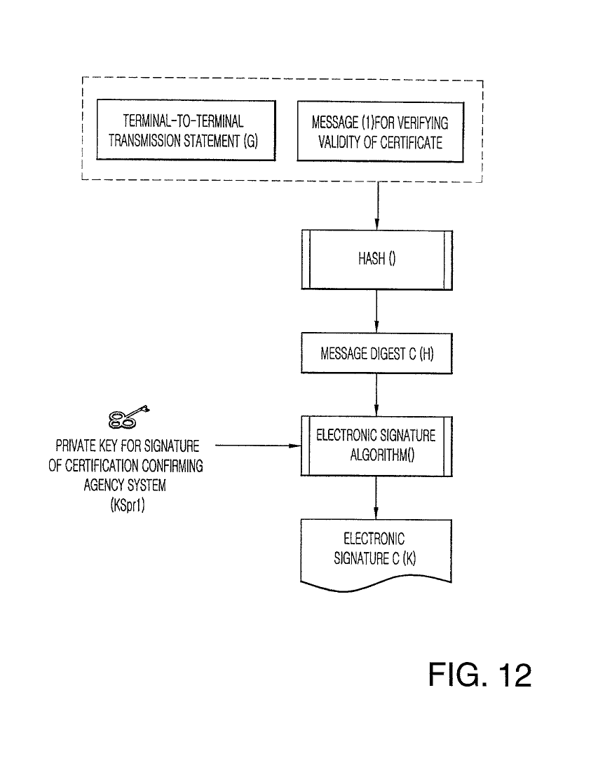

Also, as shown in FIG. 12, the certification confirming agency system 8 sends a resultant value of the certification confirmation to the application service system 9 along with the terminal-to-terminal transmission statement, sender's certificate, message for verifying the validity of the certificate, the certificate of the certification confirming agency system 8 by creating the signature value of the certification confirming agency system 8 with respect to the terminal-to-terminal transmission statement F and message for verifying the validity of the certificate.

At this time, the certification confirming agency system 8 always transmits an updated certificate to the terminal, and thus the receiving mobile terminal directly uses and manages the certificate without checking the certificate removal list.

Here, the application service system 9 according to the present invention transfers the message (i.e., certification confirming agency system-to-terminal message) returned from the certification confirming agency system 8 to a proper receiving mobile terminal 2 only when the sender certification is confirmed through the certification confirming agency system 8.

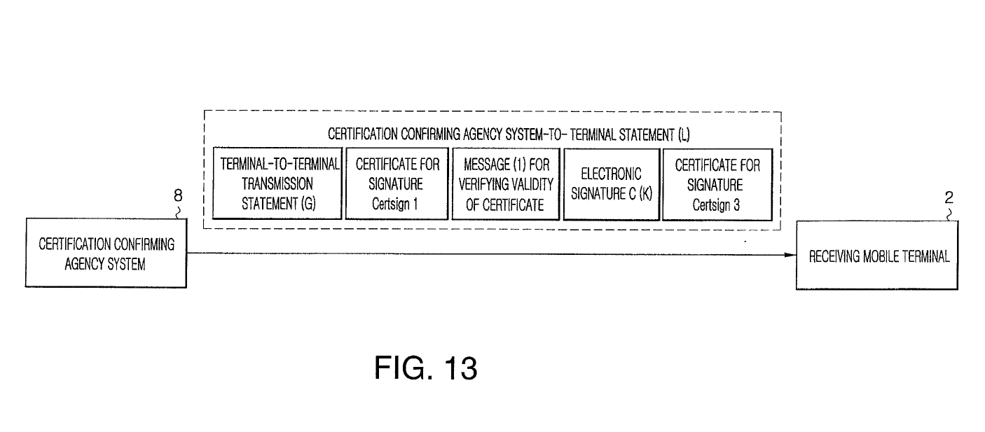

FIG. 13 shows the construction of the transmission message transmitted from the certification confirming agency system to the receiving mobile terminal through the radio network.

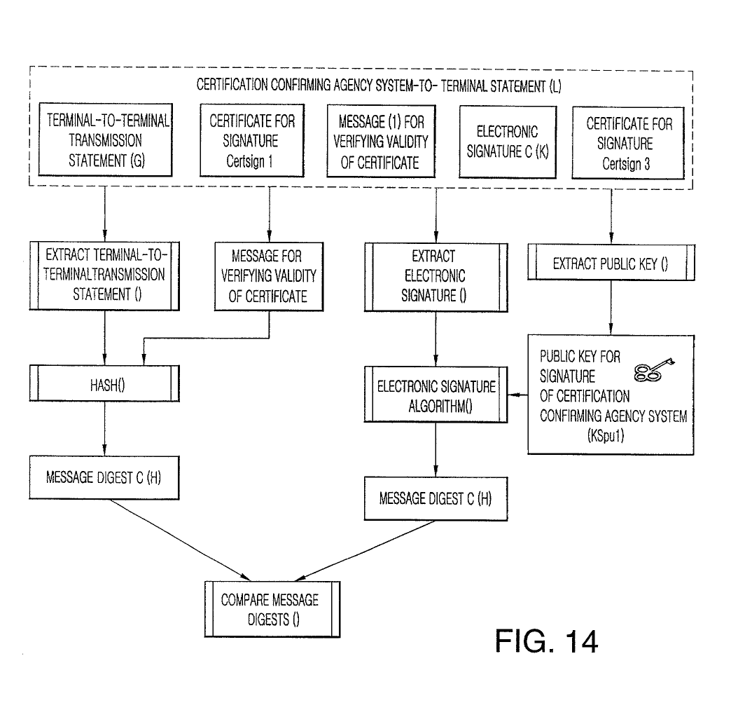

The receiving mobile terminal 2, which has received the message from the application service system 9, as shown in FIG. 14, analyzes and separates the certification confirming agency system-to-terminal transmission statement L into the terminal-to-terminal transmission statement G, sender's certificate, message for verifying the validity of the certificate, electronic signature (C) of the certification confirming agency system 8, and certificate of the certification confirming agency system 8.

FIG. 14 illustrates the electronic signature confirming process of the certification confirming agency system in the mobile terminal. It is confirmed that the received transmission statement is sent from the certification confirming agency system 8 by verifying the electronic signature value (C) of the certification confirming agency system 8.

The electronic signature value is confirmed to be proper if the resultant value obtained by decoding the electronic signature value using the public key for signature of the certification confirming agency system 8 is equal to the digest value of the terminal-to-terminal transmission statement F.

If the signature value of the certification confirming agency system 8 is confirmed as above, the validity of the sender's certificate is guaranteed, and thus the receiving mobile terminal 2 can perform the message decoding work, omitting the validity check of the sender's certificate.

The receiving mobile terminal 2 analyzes and separates the terminal-to-terminal transmission statement into the message encoding statement, session key encoding statement, and sender's electronic signature.

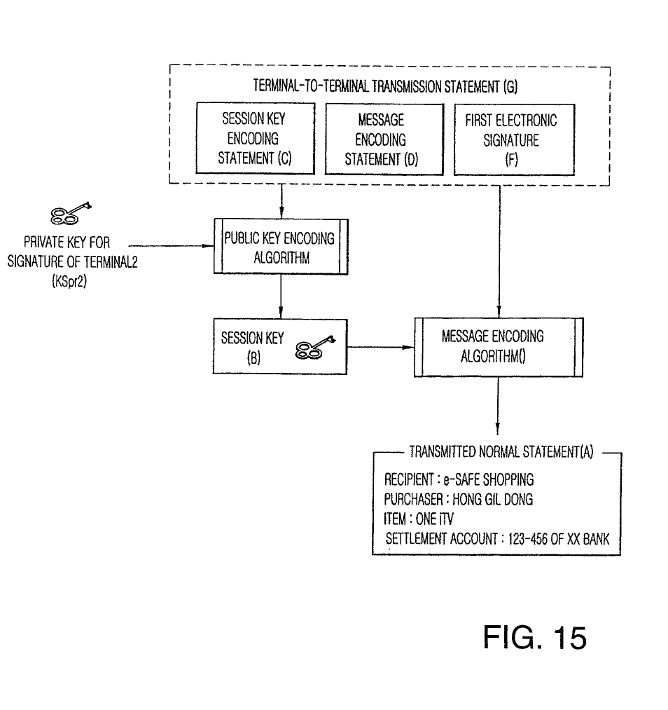

FIG. 15 illustrates the decoding process of the terminal-to-terminal message in the mobile terminal 2 that received the message. The mobile terminal 2 decodes the session key using the private key for encoding of the receiver, and restores the transmission statement by decoding the message encoding statement using the session key.

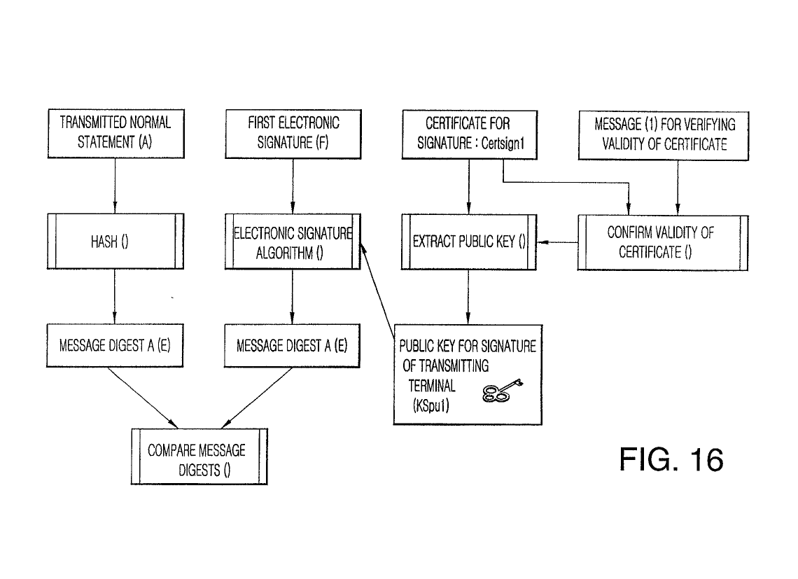

At this time, since the identity of the sender has already been confirmed in the certification confirming agency system 8, the receiving mobile terminal 2 may omit it. The confirmation of the sender's certification in the receiving mobile terminal 2 is performed as shown in FIG. 16.

Specifically, as shown in FIG. 16, the receiving mobile terminal 2 creates the message digest (A) E from the transmission statement A using the hash algorithm, restores the message digest (A) E from the first electronic signature F through the electronic signature algorithm, and compares the message digests. Then, the receiving mobile terminal 2 extracts the public key from the certificate for signature only in case that the certificate is effective through the message value for verifying the validity of the certificate, and inputs the extracted public key to the electronic signature algorithm using the public key for signature of the transmitting mobile terminal.

As described above, according to the present invention, the PKI based user certification service, that is difficult to be provided by the mobile terminal itself having a limited capacity, can be used even in the mobile terminal.

The present invention can be usefully applied to an electronic transaction field that requires a user certification in a radio network environment, and to all fields that require a security service between terminals in a radio network such as a mobile terminal-to-mobile terminal message security.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A system for providing a certification confirming agency service using a double electronic signature, comprising:
a transmitting mobile terminal for receiving a message from a user, performing a security function required for message encoding and electronic signature of a sender, and performing a message transmitting function;
an application service system for receiving the message transmitted from the transmitting mobile terminal, requesting a validity check of a sender's certificate and a sender's certification check to a certification confirming agency system, and receiving from the certification confirming agency system and transferring to a receiving mobile terminal a message of the certification confirming result;
the certification confirming agency system for receiving a request for confirming the validity of the sender's certificate and a sender's signature value from the application service system, extracting the validity of the sender's certificate and the sender's signature value by analyzing a statement transmitted from the transmitting mobile terminal through the application service system, performing the validity check with respect to the sender's certificate and signature value, and transmitting a result of checking with its signature attached thereto back to the application service system;
the receiving mobile terminal for restoring the transmitted statement by receiving and decoding the message from the application service system, and outputting a restored statement so that a receiver can view it;
a certificate issuing system for issuing electronic certificates to mobile terminal users; and
a certificate directory system for noticing the electronic certificates issued by the certificate issuing system so that wire/wireless subscribers can peruse them through a wire network and a radio network.

2. The system as claimed in claim 1, further comprising a wire/radio gateway system connected between the radio network and the wire network, and having a communication protocol conversion function of transferring the message of the radio network to the wire network and transferring the message of the wire network to the radio network if the message transmitting protocol of the radio network is different from that of the wire network.

3. The system as claimed in claim 1, wherein the transmitting mobile terminal creates a terminal-to-terminal transmission statement composed of a message encoding statement, a session key encoding statement, and a first electronic signature by receiving and encoding the normal statement message from a terminal user and creating the first electronic signature for the normal statement message by a private key for signature of the sender, creates a terminal-to-certification confirming agency system transmission statement composed of the terminal-to-terminal transmission statement, a second electronic signature, and a certificate for signature of the sender by creating the second electronic signature by the private key for signature of the sender with respect to the terminal-to-terminal transmission statement, and transmitting the transmission statements to the application service system.

4. The system as claimed in claim 3, wherein in case of encoding the normal statement message, the transmitting mobile terminal creates a session key for one time that is effective only in a communication session where the transmitting mobile terminal is connected to the receiving mobile terminal, encodes the normal statement message to be transmitted by a message encoding/decoding algorithm using the session key, encoding the session key used for the message encoding by a public key for encoding of the receiver so that only the just receiver can decode the session key, and transmits both the message encoding statement and the session key encoding statement.

5. The system as claimed in claim 3, wherein in case of creating the first electronic signature of the sender, a message digest is created by applying a hash function to the normal statement message inputted by the sender, and an electronic signature value is created by encoding the message digest using the private key for signature of the sender.

6. The system as claimed in claim 3, wherein in case of creating the second electronic signature of the sender, a message digest is created by applying a hash function to the message encoding statement and the first electronic signature of the sender as one message, and creates the electronic signature value by encoding the message digest using the private key for signature of the sender in order to perform verification of the message encoding statement and the first signature value created in the transmitting mobile terminal and certification of the sender.

7. The system as claimed in claim 1, wherein the certification confirming agency system extracts a terminal-to-terminal transmission statement, a second electronic signature value of the sender, and a certificate of the sender by analyzing the terminal-to-certification confirming agency system transmission statement from the application service system, performs the validity check for the certificate of the sender, verifies the sender certification and the terminal-to-terminal transmission statement through confirmation of the second signature value of the sender, constructing the certification confirming agency system-to-terminal transmission statement by creating the message for verifying the validity of the certificate and the electronic signature of the certification confirming system, and transmitting the transmission statement to the application service system.

8. The system as claimed in claim 7, wherein in case of checking the validity of the certificate, the certification confirming agency system checks a validity time of the certificate of the sender, and if it is checked that the certificate is in the validity time, it brings a certificate removal list for the certificate of the sender from the certificate directory system, the certification confirming agency system finally judging whether the certificate is effective by performing the certificate confirming check with respect to an issuer of the certificate of the sender if it is checked that the certificate is not in the certificate removal list.

9. The system as claimed in claim 7, wherein in case of confirming the second electronic signature value of the sender, the message digest is restored by extracting the public key for signature of the sender after completion of the validity check of the sender's certificate and decoding the second electronic signature value, a message digest is created by applying a hash function to the terminal-to-terminal message, it is judged that the electronic signature value is true and the terminal-to-terminal message is guaranteed if the two message digests are identical, and the message for verifying the validity of the certificate is created.

10. The system as claimed in claim 7, wherein in case of creating the electronic signature, the certification confirming agency system creates the message digest by applying a hash function to the terminal-to-terminal transmission statement and the whole message for verifying the validity of the certificate, and creates the electronic signature value by encoding the message digest using the private key for signature of the certification confirming agency system.

11. The system as claimed in claim 1, wherein the receiving mobile terminal receives and separates the certification confirming agency system-to-terminal message from the application service system into the terminal-to-terminal transmission statement, sender's certificate, message for verifying the validity of the certificate, electronic signature of the certification confirming agency system, and certificate of the certification confirming agency system, and restores and outputs the normal statement message by checking the electronic signature of the certification confirming agency system and analyzing the terminal-to-terminal transmission statement.

12. The system as claimed in claim 11, wherein in case of confirming the electronic signature of the certification confirming agency system, the message digest is restored by extracting the public key for signature from the certificate of the certification confirming agency system, a message digest is created by applying a hash function to the terminal-to-terminal message and the message for certifying the validity of the certificate, and if the two messages are identical, it is judged that the electronic signature value is true and the terminal-to-terminal message is not modulated.

13. The system as claimed in claim 11, wherein in case of analyzing the terminal-to-terminal message, the encoding message, encoding session key, and first electronic signature of the sender are separated, the normal statement message is restored by decoding the encoding message, and the sender certification and the message completeness are confirmed by verifying the first electronic signature of the sender.

14. The system as claimed in claim 13, wherein in case of restoring the normal statement message, the session key is restored from the encoding session key using the private key for encoding for the receiver, and the normal statement message inputted by the sender is restored by decoding the encoding message by the session key using the message encoding/decoding algorithm.

15. The system as claimed in claim 13, wherein in case of verifying the first electronic signature of the sender, the message digest is created by extracting the public key for signature of the sender from the certificate of the sender and restoring the first signature value of the sender, a message digest is created by applying a hash function to the decoded normal statement message, and judging that the electronic signature value is true if the two message digests are identical.
